(19) United States
(12) Patent Application Publication
(10) Pub. No.: US 2026/0273459 A1
(43) Pub. Date: Sep. 17, 2026

(54) METHOD AND APPARATUS FOR DRYING A FLOW RICH IN CARBON DIOXIDE

(71) Applicant: L'Air Liquide, Societe Anonyme pour l'Etude et l’Exploitation des Procedes Georges Claude, Paris (FR)

(72) Inventors: Mathieu LECLERC, Charenton-Le-Pont (FR); Felix PERE, Charenton-Le-Pont (FR)

(21) Appl. No.: 19/680,070

(22) Filed: May 18, 2026

Related U.S. Application Data
(63) Continuation of application No. 18/272,408, filed on Jan. 7, 2022, now Pat. No. 12,654,128.

(30) Foreign Application Priority Data
Jan. 14, 2021 (FR) FR2100351

(51) Int. Cl. B01D 53/26; B01D 53/047

(52) U.S. Cl. CPC B01D 53/261; B01D 53/047; B01D 53/0473; B01D 53/265; B01D 2256/22; B01D 2257/80; B01D 2259/40052

(57) ABSTRACT

In a method for drying a first wet gas stream containing at least 90 mol % CO₂, the first CO₂ stream is dried in a water adsorption unit, at least a portion of the regeneration gas from the adsorbers being a gas containing at least 90 mol % carbon dioxide produced in a separation apparatus (33) that separates a gas (31) containing carbon dioxide and at least one impurity by partial condensation and/or distillation at a temperature below 0° C.

### CROSS REFERENCE TO RELATED APPLICATIONS

This application is a continuation application of U.S. application Ser. No. 18/272,408 filed Jul. 4, 2023, which is a 371 of International Application No. PCT/EP 2022/050276, filed Jan. 7, 2022, which claims priority to French Patent Application No. 2100351, filed Jan. 14, 2021, the entire contents of which are incorporated herein by reference.

### BACKGROUND

The present invention relates to a method and to an apparatus for drying a flow rich in carbon dioxide. A flow rich in carbon dioxide contains at least 90 mol %, preferably at least 95 mol %, or even at least 98 mol % CO₂ on a dry basis.

CO₂ separation units may be disseminated within an industrial basin over a plurality of emitters. Most separation methods, for example those involving physical, chemical or physicochemical absorption, produce CO₂ at low pressure and saturated with water, such as for example amine scrubbing methods. It is therefore necessary to compress and dry the CO₂ produced before export and/or liquefaction for sequestration or use.

Synergies can be found by sharing the compression and drying units between the various emitters in order to achieve economies of scale and especially of infrastructure. In particular, sharing with CO₂ coming from a cryogenic CO₂ separation unit may afford additional savings.

It is known from FR2954179 to dry a flow rich in carbon dioxide produced by amine scrubbing using an adsorption step.

CO₂ compression and drying thereof may be configured in the following manner:
Compression of the wet CO₂ to an intermediate pressure or to the final pressure,
Cooling of the compressed gas (with a fluid at ambient temperature, such as air or refrigeration water or even with refrigerated water) making it possible to discharge a part of the water in the form of condensates,
Drying by adsorption:
   one cylinder is in production,
   the other, identical, cylinder is in parallel and in regeneration.
Regeneration is performed by the passage of a hot stream, preferably at lower pressure in order to reduce the dimensions of the dryer. The regeneration gas may be a part of the dried gas (5 to 30%). The gas that was used for the regeneration is expanded and recycled in the compressor in a section at lower pressure. The water resulting from the regeneration is thus partially eliminated jointly with the condensates.
Compression of the dry CO₂ to the final pressure in the case of drying at an intermediate pressure.

A part of the energy consumed is therefore linked to the recompression of the regeneration gas and refrigeration thereof in the case of cooling with refrigerated water.

In the case of integration of CO₂ coming from a cryogenic separation unit, CO₂ coming from the cryogenic separation is available dry and under pressure, at least at a pressure close to that of the triple point of CO₂, the cryogenic separation generally being at least partially carried out at this pressure. In the case of common compression, this CO₂ is integrated at an intermediate level of the compressor. If the cryogenic separation unit provides other streams of CO₂ at higher pressure, they can also be integrated at a nearby level in the compressor.

The dryer is usually operated at a higher pressure than the injection at the pressure close to the triple point of CO₂ for technical and economic reasons (quantity of residual water to be adsorbed, size of the adsorbers and selection of the materials of the compressors needing to be taken into account in particular).

According to one subject of the invention, there is provided a method for drying a first wet gas stream containing at least 90 mol %, preferably at least 95 mol %, or even at least 98 mol % CO₂ on a dry basis, comprising the following steps:
i) optionally, compressing the first wet gas stream to a first pressure in order to obtain a first wet gas stream at the first pressure,
ii) drying the first CO₂ stream in a water adsorption unit of the type implementing n adsorbers with, for each adsorber, a cycle comprising the following operating phases, which are offset from one adsorber to another by an nth of the duration (T) of the cycle:
   a) adsorption, this adsorption phase involving the admission of the first wet gas stream into the adsorber via a first end, called inlet end, of the adsorber, with circulation of this stream in the adsorber and simultaneous withdrawal, via the other end of the adsorber, of gas purified of water and
   b) regeneration of the adsorber during which a regeneration gas regenerates the adsorber,
the first stream being purified of water in one of the adsorbers so as to produce a dried gas while the regeneration gas is sent to another of the adsorbers, at least a part of the regeneration gas being a gas containing at least 90 mol % of carbon dioxide produced in a separation apparatus that separates a gas containing carbon dioxide and at least one impurity by partial condensation and/or distillation at a temperature of less than 0° C., characterized in that the gas containing carbon dioxide and at least one impurity is not the dried gas and is not derived from the dried gas.

According to other optional subjects:
the gas purified in the adsorption unit is compressed in a compressor with a gas containing at least 90 mol %, preferably at least 95 mol %, or even at least 98 mol % of carbon dioxide coming from the separation apparatus.
the gas purified in the adsorption unit is compressed in a compressor with a gas coming from the separation apparatus that is richer in carbon dioxide than the gas containing carbon dioxide and at least one impurity.
the first stream is compressed by at least one compression step then cooled in at least one cooler downstream of the compression step, at least a part of the water produced by the compression and the cooling being removed upstream of the adsorption.
the regeneration gas that has regenerated the adsorber is sent to be mixed with the wet stream upstream of at least one of the compression steps and at least one of the coolers.
at least a part of the regeneration gas is constituted by a part of the first stream purified in the adsorption unit.
the first stream originates from a method treating a flow containing carbon dioxide so as to enrich it in carbon dioxide, for example a physical, chemical or physicochemical absorption method or an adsorption method.
the adsorption unit is a temperature swing adsorption unit and the pressure of the adsorption is greater than that of the regeneration.
the pressure of the adsorption and the pressure of the regeneration are greater than 4.5 bar abs, preferably than 5.5 bar abs or even than 6.5 bar abs.
the adsorption pressure is at least equal to 10 bar abs.
the adsorption unit comprises two or three adsorbers.

According to another subject of the invention, there is provided an apparatus for drying a first wet gas stream containing at least 90 mol %, preferably at least 95 mol %, or even at least 98 mol % CO₂ on a dry basis, comprising:
i) Optionally, a compressor for compressing the first wet gas stream to a first pressure in order to obtain a first wet gas stream at a first pressure
ii) a water adsorption unit, of the type implementing n adsorbers with, for each adsorber, a cycle comprising the following operating phases, which are offset from one adsorber to another by an nth of the duration (T) of the cycle:
   a) adsorption, this adsorption phase involving the admission of the first wet gas stream into the adsorber via a first end, called inlet end, of the adsorber, with circulation of this stream in the adsorber and simultaneous withdrawal, via the other end of the adsorber, of gas purified of water and
   b) regeneration of the adsorber during which a regeneration gas regenerates the adsorber,
i) means for sending the first wet gas stream to the water adsorption unit,
ii) means for extracting a dried gas rich in CO2 from the adsorption unit,
iii) means for sending a regeneration gas to the adsorption unit, the means for sending a regeneration gas to the adsorption unit being connected to a separation apparatus that separates a gas containing carbon dioxide and at least one impurity by partial condensation and/or distillation at a temperature of less than 0° C. so as to use a gas containing at least 90 mol % of carbon dioxide produced by the separation apparatus as regeneration gas, characterized in that the apparatus does not comprise means for sending the dry gas or a gas derived from the dry gas to be separated in the separation apparatus.

According to other optional aspects:
the apparatus comprises means for drying the gas containing carbon dioxide and at least one impurity upstream of the separation apparatus.
the apparatus comprises an apparatus for separation by physical, chemical, or physicochemical absorption that produces the first wet gas stream.
means for sending the dry gas to an element other than the separation apparatus.

The invention makes it possible to reduce the compression and/or refrigeration energy in order to produce dry carbon dioxide from a method producing wet carbon dioxide. The size of the CO₂ dryer of the refrigeration unit and of the compression section treating the CO₂ may also be reduced. In cases in which the method uses compresses together flows resulting from the absorption and the separation at low temperature, the number of rotating machines may be reduced.

Among the innovative features of variants of the invention, there may be noted:
Operating the dryer at a pressure greater than that of the triple point of CO₂, at the outlet of a second section of the compressor.
Using the dry CO₂ coming from the cryogenic separation unit at a pressure close to the triple point of CO₂ as regeneration gas.
Recycling this regeneration gas at the outlet of a first section of the compressor.

In this way, advantage is taken of the availability of a dry gas at lower pressure than the dryer in order to regenerate it. It is not necessary to expand and recycle a part of the dry CO₂ at the outlet of the dryer, thus allowing an energy saving and reduction in the size of the equipment in the regeneration loop.

When the CO₂ separation unit is stopped or at low load, the flow of CO₂ at the pressure close to the triple point of CO₂ may prove insufficient for the regeneration of the dryer. In this case, the remainder may be provided by a part of the dry CO₂ leaving the dryer, which has been expanded.

A variant of the method according to the invention may be the common use of the intermediate cooler of the compressor in order to cool the gas resulting from the preceding compressor section and the hot gas resulting from the regeneration of the dryer.

In the case of a condensate separator separate from the intermediate cooler of the compressor, the latter may also be shared in order to separate the condensates from the gaseous CO₂ resulting from the preceding compressor section and the hot gas resulting from the regeneration of the dryer.

### BRIEF DESCRIPTION OF THE DRAWINGS

For a further understanding of the nature and objects for the present invention, reference should be made to the following detailed description, taken in conjunction with the accompanying drawing, in which like elements are given the same or analogous reference numbers and wherein:

FIG. 1 illustrates a method according to the invention.

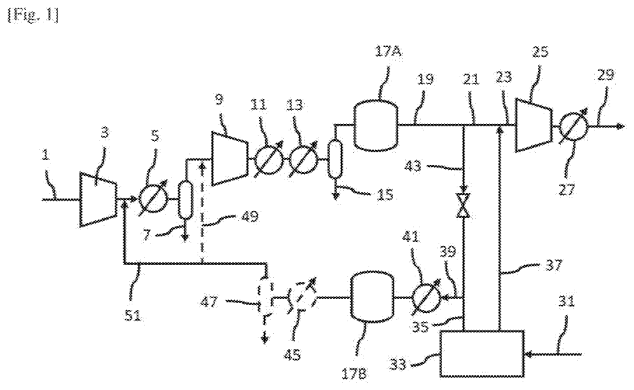

### DETAILED DESCRIPTION OF PREFERRED EMBODIMENTS

A flow 1 of gas enriched in carbon dioxide originates from a carbon dioxide separation method, such as a physical, chemical or physicochemical absorption or adsorption method treating a flow containing carbon dioxide. A plurality of separation units producing wet carbon dioxide flows can supply a single drying apparatus, according to the invention. The flow 1 contains at least 90% of carbon dioxide on a dry basis, preferably at least 95 mol %, or even at least 98 mol % CO₂ on a dry basis, and water. It is typically at a pressure between 1 and 2 bar absolute and may also contain impurities such as nitrogen, hydrogen, methane, oxygen and methanol. The flow 1 is compressed in a compression stage 3 and then cooled in a cooler 5, and this has the effect of condensing a part 7 of the water that it contains. The remaining gas is compressed in a compression stage 9 and then cooled in one or even two coolers 11, 13, and this has the effect of condensing a part 15 of the water that it contains. The dried gas is sent to one of the at least two adsorbers of an adsorption unit of PTSA (pressure and temperature swing adsorption) type comprising at least two adsorbers containing alumina. Three adsorbers may prove necessary for larger installations. While one of the adsorbers adsorbs the water in the dried gas, the other adsorber (or one of the other adsorbers) is regenerated by a regeneration gas. A dry flow 19 rich in CO₂ leaves the adsorber 17A and is compressed in a compressor 25 before being cooled in a cooler 27 so as to produce a flow of dry gas 29. If the dry flow 19 leaves the adsorber 17A at the required pressure, no compression will be necessary. Likewise, if the gas 1 is available at the pressure required for the adsorption, no compression is necessary upstream of the adsorbers 17A, 17B.

The adsorption is effected at a pressure greater than that of the triple point of CO₂, in this case at the outlet of a second section of the compressor 9. This minimum pressure may for example be between 5 and 6.5 bar abs so as to take account of the pressure drops, or even between 5 and 6 bar abs. The adsorption preferably takes place at at least 10 bar abs, for example between 18 and 20 bar abs.

A flow 31 of gas containing carbon dioxide and at least one impurity (such as oxygen, nitrogen, argon, hydrogen, carbon monoxide) is sent to a separation apparatus 33 where the gas is cooled and separated by partial condensation and/or distillation so as to produce at least one gas enriched in carbon dioxide 35 relative to the flow 31 and not containing water. If the flow 31 contains water, this has to be removed upstream of the cooling down to a temperature below 0° C. that necessarily precedes the partial condensation and/or distillation. The gas enriched in carbon dioxide 35 is therefore necessarily dry and perfectly suitable for regeneration of the adsorber 17B saturated with water, which was used previously to purify the gas 1.

This flow 31 is not the dry gas 29 and has not been derived from the dry gas 29. Preferably, it contains less than at least 90 mol %, preferably at least 95 mol %, or even at least 98 mol % CO₂ on a dry basis.

The dry gas 29 is sent to an element other than the separation apparatus 33.

The gas 35 is heated by heat exchange against the flow 31 in a heat exchanger (not shown) forming part of the separation apparatus so as to bring it to a temperature between 0 and 20° C. It is at a pressure of at least 5 bar abs, preferably at least 6 bar abs, or even at least 6.5 bar abs. This dry gas 35 coming from the separation apparatus is at a pressure close to the triple point of CO₂, for example between 5 and 6.5 bar abs, or even between 5 and 6 bar abs.

The gas 35 is heated by a heater 41 and then regenerates the adsorber 17B. The flow of regeneration gas 51 containing water is cooled in the cooler 45 so as to condense at least a part of the water that is then separated in the separator 47. The formed gas 49 may be recycled just upstream of the compression stage 9 and/or as flow 51 downstream of the compression stage 3 and upstream of the cooler 5.

This recycling makes it possible to reduce the losses of carbon dioxide.

If the separation apparatus 33 produces less gas 35 or no gas 35, the gas 43 may be used to regenerate the adsorber 17B, therefore by taking a part of the gas 19.

A gas 37 rich in carbon dioxide coming from the separation apparatus 33 may be compressed in the compressor 25 so as to form part of the product 29. It may be mixed with the gas 19 upstream of the compressor 25 or otherwise introduced at an intermediate level of the compressor according to its pressure. It preferably contains at least 90 mol %, preferably at least 95 mol %, or even at least 98 mol % of carbon dioxide.

A part of the gas 37 can also be used to regenerate the adsorber 17B. This is particularly advantageous if the gas to be dried is at a higher pressure. In this case, the adsorber 17A is operated at a pressure greater than that of the fluid 37 that has to be integrated in another stage lower than the dryer.

In this figure, the gas 35 and the gas 37 may be produced at different pressures, one corresponding to the regeneration pressure and the other to an inlet or interstage pressure of the compressor 25. They may also have different compositions.

The gas 35 and/or the gas 37 preferably contains (or contain) at least 90 mol %, preferably at least 95 mol %, or even at least 98 mol % CO₂. They are enriched in carbon dioxide relative to the flow 31.

It is also possible to use a single gas produced by the apparatus 33 to serve partly as regeneration gas and partly as product, optionally to be compressed in the compressor 25.

The use of a common compressor 25 to compress the gas rich in carbon dioxide coming from both a low-temperature separation apparatus and at least one apparatus producing wet carbon dioxide makes it possible to reduce the total number of rotating machines on the site.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for drying a first wet gas stream containing at least 90 mol % CO₂ on a dry basis, comprising:
i) compressing the first wet gas stream to a first pressure in order to obtain a first wet gas stream at the first pressure,
ii) drying the first wet gas stream in a water adsorption unit of the type implementing n adsorbers with, for each adsorber, a cycle comprising the following operating phases, which are offset from one adsorber to another by an nth of the duration (T) of the cycle:
a. an adsorption phase comprising admission of the first wet gas stream into the adsorber via a first end of the adsorber, with circulation of the stream in the adsorber and simultaneous withdrawal, via a second end of the adsorber, of gas purified of water, and
b. regeneration of the adsorber during which a regeneration gas regenerates the adsorber,
removing water from the first wet gas stream in one of the adsorbers thereby producing a dried gas,
sending the regeneration gas to another of the adsorbers, wherein the regeneration gas is produced in a separation apparatus that separates a gas containing carbon dioxide and at least one impurity by partial condensation and/or distillation at a temperature of less than 0° C., wherein the regeneration gas contains at least 90 mol % of carbon dioxide, and
wherein the gas containing carbon dioxide and at least one impurity is not the dried gas and is not derived from the dried gas.

2. The method as claimed in claim 1, wherein the gas purified in the adsorption unit is compressed in a compressor with a gas containing at least 90 mol % of carbon dioxide coming from the separation apparatus.

3. The method as claimed in claim 1, wherein the gas purified in the adsorption unit is compressed in a compressor with a gas coming from the separation apparatus that is richer in carbon dioxide than the gas containing carbon dioxide and at least one impurity.

4. The method as claimed in claim 1, wherein the first wet gas stream is compressed by at least one compression step then cooled in at least one cooler downstream of the compression step, at least a part of the water produced by the compression and the cooling being removed upstream of the adsorption.

5. The method as claimed in claim 4, wherein the regeneration gas that has regenerated the adsorber is sent to be mixed with the first wet gas stream upstream of at least one of the compression steps and at least one of the coolers.

6. The method as claimed in claim 4, wherein the first wet gas stream originates from a method treating a flow containing carbon dioxide so as to enrich it in carbon dioxide.

7. The method as claimed in claim 1, wherein the adsorption unit is a temperature swing adsorption unit and the pressure of the adsorption is greater than that of the regeneration.

8. The method as claimed in claim 1, wherein the pressure of the adsorption and the pressure of the regeneration are greater than 4.5 bar abs.

9. The method as claimed in claim 8, wherein the adsorption pressure is at least equal to 10 bar abs.

10. The method as claimed in claim 1, wherein the gas containing carbon dioxide and at least one impurity contains less than 90 mol % CO₂ on a dry basis.

11. The method as claimed in claim 1, wherein the gas containing carbon dioxide and at least one impurity contains less carbon dioxide on a dry basis than the dried gas.
